(19) United States
(12) Patent Application Publication
(10) Pub. No.: US 2023/0303800 A1
(43) Pub. Date: Sep. 28, 2023

(54) Depolymerization Method Of A Waste Polymer Material and System Therefore

(71) Applicant: Ioniqa Technologies B.V., Eindhoven (NL)

(72) Inventors: Joost Robert Wolters, Waalre (NL); Jannigje Maria Jacomina GRAVENDEEL, Nuenen (NL); Andre Banier DE HAAN, Hoeven (NL); Fabian WOUTERS, Eindhoven (NL)

(73) Assignee: Ioniqa Technologies B.V., Eindhoven (NL)

(21) Appl. No.: 18/021,060

(22) PCT Filed: Aug. 5, 2021
(86) PCT No.: PCT/EP2021/071937

§ 371 Date: Feb. 13, 2023

(30) Foreign Application Priority Data
Aug. 14, 2020 (NL) 2026273

(51) Int. Cl. C08J 11/24

(52) U.S. Cl. CPC C08J 11/24; C08J 2367/02; C08J 2377/06

(57) ABSTRACT

A method of depolymerization of waste polymer material into monomers comprises releasing at least part of the at least one dye from the waste polymer material in an alcoholic solvent without depolymerizing the condensation polymer in the waste polymer material and at conditions preventing a reaction between the dye and the alcoholic solvent, wherein the alcoholic solvent is a polyol. The alcoholic solvent is added in a weight ratio of the alcoholic solvent to the waste polymer material of between 200:1 and 10:1. The at least partially decolorized waste polymer is then separated from the alcoholic solvent, and the at least one dye is extracted from the alcoholic solvent so as to regenerate the alcoholic solvent, which is led to a storage for reuse. The condensation polymer is depolymerized in the purified recovered alcoholic solvent by using a catalyst. A reactor system for carrying out the method is also described.

### FIELD OF THE INVENTION

The invention relates to a method of depolymerizing a waste polymer material into monomers by catalyzed depolymerization, which waste polymer material comprises a condensation polymer and at least one dye.

The invention further relates to a system for carrying out said depolymerization method.

### BACKGROUND OF THE INVENTION

Such a method is known from WO2016/105198A1. According to the known method, colorants such as dyes and pigments are released from the condensation polymer upon depolymerization thereof. When water is added at the end of the depolymerization step, two phases are formed. The first phase is liquid and contains the monomer product in water and the alcoholic solvent used in the depolymerization step. The second phase is a slurry containing the colorants, the catalyst, any pigment, oligomers, as well as some of the alcoholic solvent. The two phases can be separated from each other. Subsequently, the catalyst may be separated from the additives in a washing step using a washing agent, such as dichloromethane.

In further experiments, it has been observed that a shift of color may occur during the depolymerization step. The shift is often a pronounced shift, indicating that a colorant has been transformed. It has further been observed that the transformed colorant cannot be removed from the first liquid phase containing the monomer product. The colorant then ends up in the product during crystallization, unless it is removed prior to crystallization in an adsorption step, such as in an active carbon column. A used active carbon column is however to be disposed as chemical waste, which is clearly undesirable from an environmental and cost perspective.

It is further known from WO2014/047620 to treat a waste polymer material such as polyethylene-terephthalate (PET) originating from bottles by application of a decolorization agent. Examples of decolorization agents given are ethers, such as 2-butoxyethanol and bleaching agents, such as sodium hypochlorite. The agents are applied as aqueous solutions at temperatures between 82 and 100° C. According to said publication, these agents allow to obtain a fully decolorized PET material without any yellowish color remaining that can be used for recycling. However, the use of such aqueous solutions may lead to contamination, in case that the monomer of PET, bis(2-hydroxyethyl) terephthalate, is to be recovered. Attack of water onto the PET polymer leads to hydrolysis, which constitutes an alternative for the glycolysis used to obtain the BHET monomer. Moreover, while the decolorization may be effective for bottles that are reused without entire 5 depolymerization, it is not appropriate for waste polymer material that originates from textile and such sources rather than from bottles. The concentration of color in textile may be from 2-10 wt % and is usually higher than that in bottles. Since colorants are typically organic compounds, their dissolution into an aqueous solution will merely be successful at limited concentrations of color.

JP 2004217871A discloses a method for recovering components from colored feedstock that can be used again for polymerization of polyester using a sodium-carbonate catalyst. Typical recovered components include BHET or DMT. The methods do not target the recovery of color as a commercial product. In the disclosed method, a solid-liquid separation step aiming at separating alcoholic solvent that has remained in the feedstock is essential. This is because the separation of the color from the solvent used is not complete enough in prior art methods. The known method further needs applying a load in order to be able to obtain the correct density for the decolorization.

### SUMMARY OF THE INVENTION

It is therefore an object of the invention to provide an improved depolymerization method in which the amount of colorant getting into the stream of monomer product is reduced, and which is particularly suitable for removal of colorant from textile. The invention may also be used for removing other impurities than dyes, such as flame retardants for instance.

It is a further object of the invention to provide a system with which the said depolymerization method can be carried out.

According to a first aspect, the invention provides a method of depolymerizing a waste polymer material into monomers, which waste polymer material comprises a condensation polymer and at least one dye in accordance with claim 1. The method comprises the steps of:
releasing at least part of the at least one dye from the waste polymer material in an alcoholic solvent without depolymerizing the condensation polymer and at conditions preventing a reaction between the dye and the alcoholic solvent, wherein the alcoholic solvent is a polyol;
separating the at least partially decolorized waste polymer from the alcoholic solvent;
separating the at least one dye from the alcoholic solvent in an alcoholic solvent separation step, so as to recover the alcoholic solvent; and
depolymerizing the condensation polymer in alcoholic solvent by using a catalyst, wherein the alcoholic solvent used in depolymerizing comprises substantially the recovered alcoholic solvent obtained in the alcoholic solvent separation step.

Surprisingly, it was found that a dye or a plurality of dyes can be removed from the waste polymer material prior to depolymerization such as to prevent a reaction between the dye and the alcoholic solvent. The alcoholic solvent acts herein as a carrier for the removal of the colorant, such as the dye. The stream of alcoholic solvent comprising the colorant is particularly led to an alcoholic solvent separation stage, so as to remove the colorant again from the alcoholic solvent.

Separation of the dye(s) from the alcoholic solvent is essential in being able to re-use the recovered and purified alcoholic solvent in depolymerizing the condensation polymer. Indeed, a colored pre-treatment solvent such as ethylene glycol, may slow down the depolymerization to such extent that it is no longer efficient. Indeed, colored dyes or other additives may likely interfere with the catalyst used in depolymerization. Some dyes like anthraquinone (AQ) dyes may not influence depolymerization, while others, like azo dyes for instance, may do so.

The condensation polymer, such as polyester, is typically colored by disperse dyes. Such disperse dyes may comprise azo and anthraquinone dyes. Other possible disperse dyes may include quinophtalene, aminoketone, methine, nitro/nitroso and coumarine. In addition to the above mentioned dyes that are typically used for polyester, it is also possible that other types of dyes enter the pre-treatment solvent. This is because the polyester, for instance in textile form, may be combined with other materials such as cotton, nylon and elastane. The dyes in the context of the present invention may also include optical brighteners and/or fluorescent whitening agents. Of these, preferred for use with polyester textile for instance are the ones based on stilbene derivatives. Examples of suitable optical brighteners are OB-1, given by the following formula:

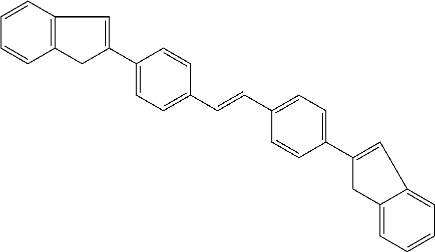 [SMILES: C1=C(c2ccc(/C=C/c3ccc(C4=Cc5ccccc5C4)cc3)cc2)Cc2ccccc21]

and blankophor B, given by the following formula:

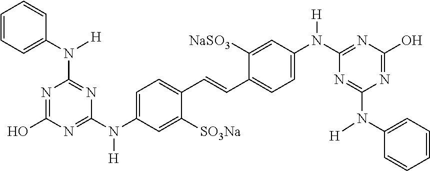

The waste polymer, or waste polymer textile, may also comprise particulate whiteners such as titanium dioxide (TiO₂). These are typically not or only partly dissolved in the solvent but do not seem to substantially affect depolymerization.

According to the invention, de-colorization is carried through far enough to avoid having to use a solid/liquid separation step, such as described in JP 2004217871A. Indeed, the part of the alcoholic solvent in the colored polymer feedstock is also the alcoholic solvent that is needed for the depolymerization of the condensation polymer itself.

The invented method is configured to substantially completely decolorize the colored polymer feedstock to a larger extent using an increased amount of alcoholic solvent as compared to that used in the state of the art. Preferably decolorizing to a larger extent means to substantially completely decolorize the colored polymer feedstock. The increased amount of alcoholic solvent may seem illogical at first sight due to the higher consumption of the alcoholic solvent. However, it has turned out that the advantages outweigh the disadvantages. The (almost) complete de-colorization of the alcoholic solvent overcomes adverse effects of the dyes and other impurities in the remaining method. For instance, reaction kinetics of the depolymerization process using the purified recovered alcoholic solvent are substantially unaffected or remain at an acceptable level. Further, separating means such as activated carbon columns are less polluted, and there is less risk for obtaining a monomer, such as BHET, that is out-of-spec. There is of course the possibility to separate dyes from the obtained monomer mixture, but this would lead to a loss of monomer, or other depolymerized components.

The step of releasing at least part of the at least one dye from the waste polymer material in the alcoholic solvent, and separating the at least partially decolorized waste polymer from the alcoholic solvent, may be carried out in a first mixing chamber in which the waste polymer material and the alcoholic solvent are mixed, preferably under stirring, and the at least one dye is released from the waste polymer material and taken up by the alcoholic solvent. A first separator is then used to separate the dye-depleted waste polymer material from the dye-containing alcoholic solvent.

According to a preferred embodiment of the invention however, a method is provided wherein the waste polymer material/alcoholic solvent extraction and separation step comprises extracting the dye from the waste polymer material by the alcoholic solvent, and separating the dye-depleted waste polymer material from the dye-containing alcoholic solvent in the same method step. Extraction may be carried out in a continuous stirred-tank reactor (CSTR), also known as a mixed flow reactor (MFR), or in a series of such continuous stirred-tank reactors. In another embodiment, the extraction may be performed in an extractor preferably using counter-current and screw transport. In the preferred counter-current extraction, the polymer waste material form which the at least one dye is to be extracted is moved in one direction (optionally in the form of flakes) within extraction means, for instance a cylindrical extractor, by conveying means, such as a conveying screw, where it comes in contact with the alcoholic extraction solvent that flows in counter-current with respect to the conveying direction. The further the starting material moves, the more concentrated the extract becomes.

In other preferred embodiments, the waste polymer material may be provided statically in an extraction means, and the alcoholic solvent moved within or around the waste polymer material. In yet other embodiments, a plurality of extraction means may be provided in series, in which alcoholic solvent may be fed back from an extraction means to a previous extraction means. Such an embodiment of the method comprises at least a first and a second releasing step wherein the second releasing step uses recovered alcoholic solvent from the first releasing step. The amount of releasing steps may be selected to obtain a substantially discolored waste polymer, and may be at least 2, more preferably at least 3, even more preferably at least 4, even more preferably at least 5, even more preferably at least 6 and up to 10-15.

The alcoholic solvent separation step that separates the dyes from the alcoholic solvent prior to depolymerizing forms a seamless step with the remaining steps of the process. From the viewpoint of recovering the dyes from the polymer feedstock, it is also advantageous to perform the alcoholic separation in one step. Such a step may involve a relatively large amount of alcoholic solvent. However the invented method comprises regenerating the alcoholic solvent in a purified form.

According to the invention a relatively large amount of alcoholic solvent may be defined in terms of parts by weight of alcoholic solvent relative to the weight of the waste polymer material feedstock. A suitable weight ratio of alcoholic solvent to waste polymer material feedstock may be between 200:1 and 10:1, more preferably between 150:1 and 20:1, more preferably between 150:1 and 30:1, even more preferably between 120:1 and 40:1. When using recovered alcoholic solvent in a releasing step, the same amounts apply. When using recovered alcoholic solvent in a plurality of subsequent releasing steps, the same amounts apply in each releasing step.

A further advantage of using a relatively large amount of alcoholic solvent is that other impurities besides dyes may also be separated from the waste polymer material feedstock and from the alcoholic solvent to obtain the recovered purified alcoholic solvent. For instance, flame retardants used in the waste polymer material may be substantially removed by the invented method and system.

It is understood that polyols such as glycols and glycerols have excellent properties for acting as a carrier: their polarity is higher than monoalcohols, which leads to reduced miscibility with many organic solvents, such as halogenated alkanes and aromatic compounds, which are not entirely non-polar. Secondly, while polyols may extract colorants such as dyes from the condensation polymer, dyes tend to transfer to the less polar solvent in the alcoholic solvent separation step, for instance by an extraction step. Furthermore, polyols are neither problematic from a health perspective nor from an environmental perspective. The, optional additional, use of effective but more problematic solvents such as xylene or chloroform can thus be limited to certain steps, thereby reducing exposure and facilitating industrial operation. In a preferred embodiment of the method, the step of releasing at least part of the at least one dye from the waste polymer is carried out without a non-alcoholic or aromatic solvent, such as xylene and/or chloroform. It is a further advantage that the alcoholic solvent selectively releases dyes rather than pigments. As a consequence, pigments—if present—can be recovered in a later stage of the process. This enables separation of pigments and dyes and moreover facilitates regeneration of the alcoholic solvent.

Please note that the recovered alcoholic solvent may also be re-used in other steps of the method besides the depolymerizing step, such as in the releasing step.

It has turned out that in preferred embodiments, the method is characterized in that the alcoholic solvent separation step is carried out such that the recovered alcoholic solvent has a purity of at least 95 wt-%, preferably of at least 98 wt-%, and more preferably of at least 99 wt-%. Suitable methods for achieving this are disclosed further below. The purity of the recovered alcoholic solvent may be defined as the wt % of solvent relative to the total weight of solvent and dye. Purity may be measured by weighing. Another suitable method may determine the color of the recovered alcoholic solvent by UV-vis.

The alcoholic solvent used in the invented method comprises a polyol. Preferred embodiments comprise methods wherein the alcoholic solvent is a glycol, more preferably an alkylene glycol, selected from ethylene glycol (1,2-ethane diol), propylene glycol (1,3-propane diol), 1,4-butane diol and 1,5-pentane diol. Although each alkylene glycol solvent may be used for depolymerizing any condensation polymer, ethylene glycol is particularly preferred when depolymerizing polyethylene terephthalate (PET) polymer, while 1,3-propane diol for instance is particularly preferred when depolymerizing polytrimethylene terephthalate (PTT) polymer, An alcoholic solvent comprising 1,4-butane diol may be particularly preferred when depolymerizing polybutylene terephthalate (PBT) polymer.

Any separation method may in principle be used for separating the at least one dye from the alcoholic solvent in the alcoholic solvent separation step, so as to recover the alcoholic solvent. However, some methods have proved to be more effective than others in separating the at least one dye from the alcoholic solvent. One of these methods may be preferred, depending on solvent properties like boiling point and solubility of the dye in the alcoholic solvent, for instance. The separating methods according to the embodiments described below may also be combined in any combination.

According to an embodiment of the invention, a method is provided wherein the alcoholic solvent separation step comprises extracting the dye from the alcoholic solvent. Extraction may be carried out in a continuous stirred-tank reactor (CSTR), also known as a mixed flow reactor (MFR), or in a series of such continuous stirred-tank reactors. Extraction may also be performed in an extractor preferably using counter-current and screw transport. In the preferred counter-current extraction, the material to be extracted is moved in one direction (optionally in the form of a fine slurry of alcoholic solvent) within a cylindrical extractor where it comes in contact with extraction solvent. The further the starting material moves, the more concentrated the extract becomes.

In the extraction process, the dyes may be extracted from the alcoholic solvent using a second solvent that is immiscible with the alcoholic solvent. Suitable second solvents are chosen from the group of alkanes, cycloalkanes, esters, and ethers, with the exclusion of aromatics. Halogenated hydrocarbons may also be used, preferred halogenated hydrocarbons including halogenated methanes and ethanes, and particularly chlorinated methanes and ethanes such as dichloromethane, dichloroethane, chloroform. Preferred ethers are ethers that are immiscible with polyols and do not contain a hydroxyl-group. More preferably, the ethers are aliphatic compounds, such as methyl t-butyl ether, ethyl ether, di-isopropyl ether, tetrahydrofuran, dimethyl ether. Aromatic compounds such as toluene, xylene, benzene, ethylbenzene, chloro-benzene, dichlorobenzene may also be used as second solvent, in preferred embodiments.

The extraction process is typically carried out at a temperature not exceeding the boiling point of the extraction solvent. Preferably, the temperature does not exceed a temperature of 10° C. below the boiling point of the extraction solvent, so as to prevent or limit evaporation of the solvent. The extraction may be carried out at room temperature or even below room temperature.

Rather than using a single alcoholic solvent, use can be made of a first and a second extraction process, wherein different solvents are used. Dependent on the choice of the solvents and the dyes, the second extraction could be applied in exchange with the alcoholic solvent and/or in exchange with the solvent of the first extraction. The use of different extraction solvents facilitates separation of different dyes from each other.

Yet another preferred embodiment provides a method wherein the alcoholic solvent separation step comprises separating the dye from the alcoholic solvent with a carbon adsorption means. Carbon adsorption means comprise activated carbon in the form of powdered or granulated activated carbon. Typically, activated carbons are made in particulate form as powders or fine granules less than 1.0 mm in size with an average diameter between 0.15 and 0.25 mm. Thus they represent a large surface to volume ratio with a small diffusion distance. So-called PAC material may also be used and generally represents finer material, made up of crushed or ground carbon particles. The ASTM classifies particles passing through an 80-mesh sieve (0.177 mm) and smaller as PAC. On the other side, granular activated carbon (GAC) may also be used. GAC has a relatively larger particle size compared to powdered activated carbon and consequently, presents a smaller external surface. Extruded activated carbon (EAC) comprising fused together powdered activated carbon with a binder may also be used. Polymer coated activated carbon may also be used.

Yet another preferred embodiment provides a method wherein the alcoholic solvent separation step comprises treating the alcoholic solvent in a distillation stage to deliver a distillation stream comprising the alcoholic solvent in an output concentration of at least 95 wt-%,

In a fourth preferred embodiment of the method, the alcoholic solvent separation step comprises a nano-filtration step to separate the dye from the alcoholic solvent. Nano-filtration basically comprises a membrane filtration-based method that uses a membrane having nanometer sized through-pores passing through the membrane. Typically, nano-filtration membranes have pore sizes in the range of 1-10 nanometer, which is smaller than used in micro- and ultrafiltration. Membranes used are predominantly created from polymer thin films, or metals such as aluminum. Pore areal densities may range from 1 to more than 100 pores/cm².

In order to substantially prevent any reaction between the alcoholic solvent and the dye or dyes, the releasing step is preferably carried out at a temperature of at most 160° C., more preferably of at most 150° C., and at further preference between 100 and 140° C. It is not deemed necessary to apply reduction or increase in pressure. The reaction to be prevented is particularly an esterification or a trans-esterification reaction. Such a reaction occurs easily and leads to a change in color, for instance from blue to red. It has been found in investigations leading to the invention, that the dye may be removed more easily from the polyol alcoholic solvent when a modification such as (trans)esterification is prevented. This is desired so as to ensure that the polyol alcoholic solvent can be purified and recycled.

In one embodiment, a second releasing step is performed after that the dye release has occurred and the alcoholic solvent is separated from the waste polymer material. Such a second releasing step is suitably carried out at a higher temperature than the first releasing step, so as to allow further release of dyes that may be present in the waste polymer material, rather than at a surface thereof. Preferably, such a second releasing step is carried out in the same chamber as the first releasing step. This is carried out in that the solid waste material is redispersed into—fresh—alcoholic solvent. Thereto, an outlet of the separator is suitably closed during redispergation. More preferably, use is made of a combined reaction chamber and separator. This can for instance be achieved with a centrifuge chamber.

While the release step of the present invention is carried using a polyol alcoholic solvent, it is not excluded that the polyol alcoholic solvent, as provided into the chamber for the release step, further contains water. In such case the weight ratio of the polyol and the water is suitably at least 1, preferably at least 3 (75 wt % polyol, 25 wt % water), more preferably at least 8 or 9 (90 wt % polyol, 10 wt % water) or 19 or more (95 wt % polyol, 5 wt % water). Water has turned out to be a highly suitable cooling means for a polyol after the release step. Such a cooling is desired so as to increase a range of extraction solvents. While water may be undesirable for the depolymerisation in view of a risk of hydrolysis—rather than glycolysis—, the presence of water during the dye release step has not been found to be problematic.

The condensation polymer is more particularly polyester. One preferred example of polyester is PET, but other polyesters are not excluded. Examples thereof include polylactic acid, polybutylene terephthalate (PBT), polytrimethylene terephthalate (PTT), polyethylene naphthalate (PEN), vectran (a condensation polymer of 4-hydroxybenzoic acid and 6-hydroxynaphthalene-2-carboxylic acid), poly (3-hydroxybutyrate-co-3-hydroxyvalerate) (PHBV), polyethylene adipate (PEA), polyhydroxybutyrate (PHB), polyhydroxyallkanoate (PHA), polycaprolactone (PCL), polyglycolic acid (PGA), polyethylene furanoate (PEF), polybutylene furanoate (PBF), poly(cyclohexanedimethylene terephthalate) (PCT). In textile fibers, PET, PTT and PEN are currently most common polyester materials. PEF and PBF are recently introduced polyesters that may be generated from biomaterials. The use of PET currently outweighs any of the other polyesters.

In addition to polyester, polyamide may be part of the waste polymer material. It has been found that the use of a polyol as an alcoholic solvent removes dyes both from the polyamide and the polyester materials. Nylons, such as nylon-6 and nylon-6,6, are well known examples of polyamides.

In a further embodiment, the polyamide is separated from the polyester subsequent to the dye release step. The separation of polyamide and more particularly nylon-6 from other materials is carried out in a heating step to a temperature above 150° C., for instance 155° C. in a polyol such as glycerol or ethylene glycol, as is known per se from WO98/35998. Thus, the nylon-6 can be removed as a separate stream by means of filtration or centrifugation after heating to a desired temperature. In one embodiment, the removal of the nylon-6 material by dissolution could be carried out in the same chamber as the releasing steps. While this is not deemed strictly necessary, this has the advantage that the waste solid material need not to be transported from a first chamber to a further chamber before it is so far disintegrated that it forms a processable liquid stream, rather than a mixture of discrete solid parts and liquid. The latter is particularly relevant if the polymer waste material originates from textile. While polyester from packaging materials such as bottles is typically pre-processed into flakes of limited dimensions, waste textiles may have larger dimensions. Moreover, textiles are generally based on fibers that may lead to clogging.

In case that nylon-6 and dyes end up in the same stream, they may be separated subsequently, for instance by means of extraction. Alternatively, the extraction may be preceded by a cooling step and a separation step so as to solidify the nylon material, which can then be separated, for instance by means of filtration.

In a further step or further embodiment, further polyamide may be removed by dissolution by increasing the temperature to above 170° C., such as above 190° C. Use can be made again of filtration or centrifugation. It is observed that it is feasible to remove all polyamide at once, by heating to a temperature above 170° C. such as above 190° C. However, in the latter case, the temperature may be too high for filtration. In one embodiment the temperature of the mixture is reduced. One may for instance use a heat exchanger, for instance a heat exchanger in which the mixture is heat exchanger with a stream of the alcoholic solvent. In an alternative embodiment, a further solvent having a lower temperature can be added, such as for instance hot water, more particularly water of 90° C. or more, such as boiling water. While this may lead to some precipitation of polyamide, the polyester and the polyamide can still be separated from each other using a filter with a coarse mesh, suitably a mesh larger than 0.2 μm. The polyamide may subsequently be removed from the solvents (i.e. a mixture of water and polyol such as ethylene glycol) over a second filter. It is observed that the addition of such further solvent may occur downstream to a first separator used for separation of the polyester from the polyamide, for instance when the first separator is a centrifuge that is resistant to high temperatures.

After optional removal of at least part of the polyamide, such as nylon-6, the process may proceed to depolymerization of the polyester using a catalyst. Suitable catalysts for depolymerizing the condensation polymer comprise a functionalized magnetic particle that is functionalized with a catalytic moiety, such as those described in NL2018269 and PCT/NL2016/050920 in the name of the applicant, which are included herein by reference. More particularly, the depolymerization is carried out at a temperature of at least 170° C., preferably at least 180° C. in the alcoholic solvent using a catalyst. The catalyst concentration may be varied. Preferably, the catalyst concentration is between 0.01 and 10 wt % relatively to the amount of polyester, for instance between 0.08 and 5 wt %. Rather than a single catalyst, a mixture of catalysts may be used. At the specified temperatures, the catalyzed depolymerization by means of glycolysis is selective for polyester, and more particularly PET.

In the event that polyamide is present in the polymer waste material that is depolymerized, the polyamide will not be depolymerized substantially. The polymer and any oligomers can then be separated from the monomer product of the depolymerization. Herewith, it is beneficial that nylon-6,6 is merely slightly soluble in boiling water and otherwise not soluble in water or water/alcohol mixtures. Therefore, upon cooling and addition of water at the end of the depolymerization step, any nylon-6,6 will get into the solid phase that further comprises the catalyst rather than the product containing the monomer of the polyester. The solid phase can thereafter be upgraded, so as to remove different constituents thereof.

It is observed that the second phase that is obtained upon the addition of water at the end of the depolymerization step typically comprises pigment and/or dyes. Pigments tend to dissolve into the alcoholic solvent prior to depolymerization less than dyes. Moreover, it is not deemed necessary to remove all dyes or other colorants from the waste polymer material prior to depolymerization. The pigments are generally removed from the aqueous phase by centrifugation. To the extent that any pigment or dye remains in the aqueous phase, their concentration will be low. They can be removed therefrom by means of adsorption, such as adsorption on an active carbon column, without any excessive costs for the adsorption columns.

In one further embodiment, the polyol alcoholic solvent comprising released dye is cooled down after its separation from the solid waste polymer material and before the solvent separation step. Suitably, the cooling down comprises a step of heat-exchanging the polyol alcoholic solvent with another stream, such as a polyol alcoholic solvent that is led towards the first chamber. In one further option, the solvent extraction process may be arranged so as that a first extraction solvent is also used for cooling down the polyol alcoholic solvent. The first extraction solvent may have a boiling point of at least 100° C. and preferably at least 110° C. or even at least 120° C. If desired, a further extraction may then be carried out with a second extraction solvent having a lower boiling point, such as a halogenated alkane, for instance chloroform, dichloromethane, dichloroethane and the like.

Alternatively, or additionally, water may be added as a cooling means. In itself, the addition of water leads to a mixture of the polyol and water, which may be undesired for depolymerization in view of risking hydrolysis of the condensation polymer rather than glycolysis. However, the presence of water in the polyol is not deemed detrimental as long as the temperature of the release step is low enough to avoid depolymerization. Furthermore, the water concentration can be controlled in the storage vessel through the addition of fresh polyol. Furthermore, a stream of polyol/water mixture may be treated, for instance by means of distillation, in order to separate the water from the polyol.

According to a second aspect, the invention provides a system for depolymerizing a waste polymer material comprising a condensation polymer and a dye, said system comprising:
(1) heating means for heating up an alcoholic solvent;
(2) a first chamber for mixing the waste polymer material in the alcoholic solvent, wherein the waste polymer material is heated up by means of the alcoholic solvent, said first chamber being provided with an inlet for the alcoholic solvent and with an inlet for the waste polymer material, wherein in use upon heating up of the waste polymer material the dye will be released from the waste polymer material at least partially and into the alcoholic solvent;
(3) a first separating stage, optionally integrated with the first chamber, for separating the waste polymer material in solid form from the alcoholic solvent and having a first outlet for the alcoholic solvent;
(4) a further separating stage for separating the dye from the alcoholic solvent to obtain recovered alcoholic solvent, said separating stage being arranged downstream of the first outlet of the first separator;
(5) a storage vessel for the recovered alcoholic solvent, which storage vessel includes an inlet coupled to the separating stage, and further an outlet coupled to a further chamber;
(6) which further chamber is provided for depolymerization of the condensation polymer, and is provided with a first inlet for the waste polymer material, optionally with a further inlet for depolymerization catalyst, and with a further inlet for the recovered alcoholic solvent.

The reactor system of the invention enables recycling and re-use of the alcoholic solvent in an effective manner. Heating means are herein arranged so as to heat up the alcoholic solvent, and then to transfer the heat from the alcoholic solvent to the waste polymer material. This is done so as to prevent lack of uniformity in the temperature distribution in the first chamber. The latter entails the risk that the temperature would locally, for instance at a reactor wall, be increased to a reaction temperature of the dye and the alcoholic solvent.

An embodiment of the invention provides a system wherein the first chamber and the first separating stage are integrated and jointly constitute a mixing/separator unit in which the waste polymer material may be retained (statically) in the first chamber and the alcoholic solvent is fed to the first chamber and led through or along the waste polymer material to extract the dye contained therein. The dye-containing alcoholic solvent than exits the first chamber through an outlet. In this way, the first separator for separating the solid waste polymer and the alcoholic solvent is not a separate component of the mixing/separator unit but separation is implicit.

In another embodiment, a system is provided wherein the first chamber and the first separator are integrated and jointly constitute an extraction unit in which the waste polymer is retained or is advanced with mechanical means, such as a conveying screw, provided within the first chamber, and the alcoholic solvent is fed to the first chamber, preferably in counter-current flow relative to the conveying direction of the mechanical means. A tray or other separating means than acts as the first separator.

In order to ensure that the mixture of waste polymer material and the alcoholic solvent has a substantially uniform temperature, dye release is preferably carried out in a rotating vessel. More particularly, the rotating vessel is configured to act as a centrifuge chamber. A rotating vessel, such as for instance used in a washing machine, is sufficiently strong to carry the load of the waste polymer material. Moreover, by limitation of the temperatures, a significant physical or chemical degradation does not occur.

In one embodiment, the waste polymer material may be transported mechanically to a subsequent vessel or reaction chamber, after the release step. Tools may be provided for this purpose, such as one or more grippers or other mechanical means for removal of solid material from one location to a second location. A conveyer belt can be applied as a supplementary means of movement.

Alternatively, the solid material may be re-dispersed into a liquid, such as the alcoholic solvent, which is not preferred. It can then be transported, for instance in the form of flakes or a dispersion of flakes. An embodiment of the invention provides a system wherein the first chamber and the first separator jointly constitute a centrifuge chamber, wherein at least one valve is present such that the alcoholic solvent may be selectively retained in the centrifuge chamber or removed therefrom.

Yet another embodiment relates to a system wherein the releasing stage comprises an extraction apparatus for extracting the dye from the alcoholic solvent, preferably with a second solvent that is immiscible with the alcoholic solvent, said extraction apparatus being preferably provided with an inlet for the second solvent.

Another embodiment provides a system wherein the separating stage comprises a carbon absorption means for separating the dye from the alcoholic solvent.

In yet another embodiment of the invented system, the separating stage comprises a distillation means for delivering a distillation stream comprising the alcoholic solvent in an output concentration of at least 95 wt-%.

A system according to yet another embodiment is characterized in that the separating stage comprises a nano-filtration stage for separating the dye from the alcoholic solvent.

The reactor system further comprises a further chamber for depolymerization of the condensation polymer, which further chamber is provided with a first inlet for the waste polymer material and with a further inlet for catalyst, and optionally again a further inlet for the alcoholic solvent, and a further separator for separating a catalyst from a solution comprising monomers after depolymerization of the condensation polymer. A further inlet for water may additionally be present so as to effect precipitation of oligomers and create a first, aqueous phase comprising monomer product and a second phase comprising catalyst, oligomers and additives. The advantage of using a further chamber for the depolymerization is that it allows simultaneous processing of the decolorization pre-treatment and the depolymerization. A further advantage is that the further chamber may be configured for addition of a significant amount of water, and for separation of the aqueous stream without risk of contamination with outlet lines in which some released dye may be retained. Furthermore, the use of a separate reactor in which temperature control appears less critical allows instalment of heating means within the reactor. Furthermore, a specific design for the reactor can be used. An example of such reactor design is a combination of a heating vessel and one or more plug-flow reactors, such as disclosed in the application WO2016/205200A1, which is 5 herein included by reference.

In one further embodiment, the alcoholic solvent is heated to a predefined temperature prior to entering the preferably rotating vessel in which releasing is carried out. Preheating the alcoholic solvent rather than heating in the vessel, allows that the temperature in the vessel does not exceed a predefined temperature limit. In a specific implementation hereof, it is furthermore feasible to carry out dye release in a series of consecutive steps, such as a first step and a second step. Each step can be carried out at a predefined temperature and for a predefined duration. This may allow obtaining selective release of dyes, for instance dyes that have been added to the textile by printing from dyes that have been incorporated earlier in the manufacture process. It further allows selective release of dyes from textile material and thereafter selective release of dyes from polyester bottles, such as PET bottles. Such selective release of dyes facilitates the downstream extraction process so as to isolate individual dyes, which can be reused for coloration purposes rather than that they need to be disposed as chemical waste.

In one further embodiment, the first chamber and the first separator are mutually arranged, such that the separated waste polymer material in solid form can be redispersed in the first chamber by addition of the alcoholic solvent. This allows carrying out multiple steps in the first chamber without the need of transportation of solid material. One implementation thereof is that the first chamber and the first separator jointly constitute a centrifuge chamber, wherein at least one valve is present such that the alcoholic solvent may be selectively retained in the centrifuge chamber or removed therefrom.

In again a further embodiment, a filter is arranged downstream of said first outlet of the first separator for carrying out a solid-liquid separation treatment at different conditions than in the first separator. Such filter is for instance deemed suitable for separation of polyamide. In a preferred implementation, cooling means are present upstream of said filter and downstream of the first outlet. One embodiment of a cooling means is a heat exchanger. An alternative embodiment of a cooling means is an inlet for a cooling agent, such as water. The cooling agent is thereafter mixing with the polyol alcoholic solvent. Mixing means may be provided thereto. Such mixing means may include a mixing chamber and/or a stirrer, as known per se to the skilled person. In a further implementation, a bypass is present around the filter. This allows that the filter can be integrated downstream of the first separator and upstream of the extraction apparatus, without the need that any solvent stream passes the filter. Alternatively, the filter may be arranged in a separated circulation line, with or without any further extraction apparatus downstream of the filter for the filtrate.

In an advantageous embodiment, the heating means are arranged downstream of the storage vessel and a heat exchanger is present upstream of said heating means for heat exchange between the alcoholic solvent from the storage vessel and a stream of alcoholic solvent comprising released dye originating from the first separator. This embodiment is energy efficient.

In again a further embodiment, the heating means are provided with a temperature sensor and a controller, so as to specify the heating of the alcoholic solvent to a predefined temperature. Temperature sensors may be arranged at different locations, such as in the first chamber, downstream of the heating means, upstream of the heating means. The number of temperature sensors can be chosen as desired. The implementation hereof is known to a skilled person in the field of reactor design.

### BRIEF INTRODUCTION OF FIGURES

These and other aspects will be further elucidated with reference to the figures and examples, wherein:

FIG. 1 is a schematic layout of a reactor system according to a first embodiment;

FIG. 2 is a schematic layout of a reactor system according to a second embodiment;

FIG. 3 is a schematic layout of a reactor system according to a third embodiment;

FIG. 4 is a schematic graph of the relative absorbance versus the number of pre-treatment cycles;

FIG. 5 is a schematic graph of the PET to BHET conversion (%) versus depolymerization time for a textile after one pre-treatment cycle and after six pre-treatment cycles;

FIG. 6 is a schematic layout of a reactor system according to a fourth embodiment; and

FIG. 7 is a schematic layout of a reactor system according to a fifth embodiment of the invention;

FIG. 8 is a schematic graph of the PET to BHET conversion (%) versus depolymerization time for a textile for different solvent to waste polymer ratios during the pre-treatment cycle;

FIG. 9 is a schematic graph of the PET to BHET conversion (%) versus depolymerization time for a textile for different solvent to waste polymer ratios and number of pre-treatment cycles; and

FIG. 10 shows a bar diagram of the amount of phosphorous flame retardant after different pre-treatments.

### DETAILED DISCUSSION OF ILLUSTRATED EMBODIMENTS

The figures are not drawn to scale and equal reference numerals in different figures refer to equal or corresponding features.

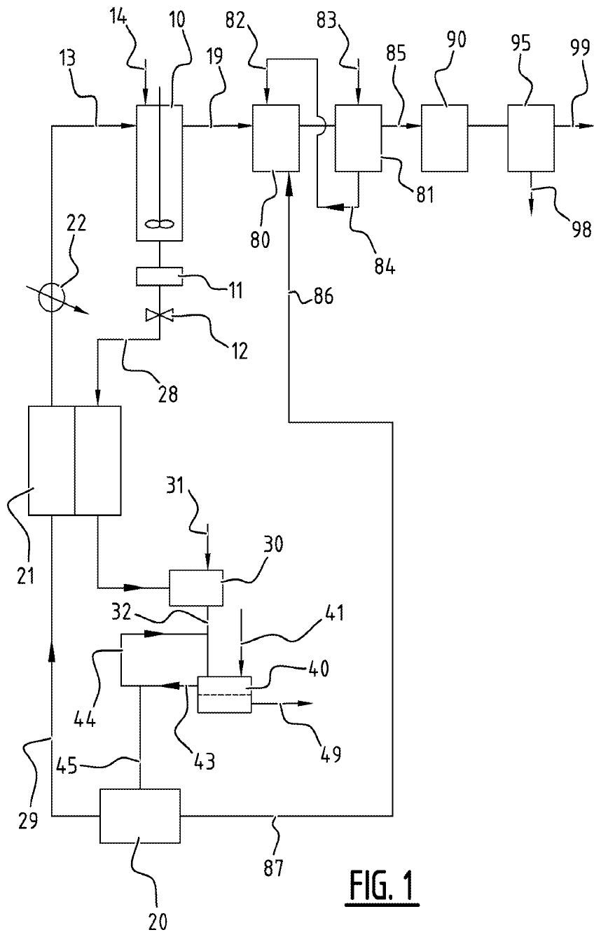

FIG. 1 shows a schematic layout of a reactor system according to a first embodiment of the invention which allows recycling of the alcoholic solvent. The alcoholic solvent in accordance with the invention is a polyol, more preferably a glycol, such as a C₂-C₅ glycol, and more preferably ethylene glycol. The use of ethylene glycol is preferred, as it can be used both as solvent for release of dyes and as a solvent and reactant in the depolymerization. As such, the use of ethylene glycol in the dye release step does not lead to contamination of the polymer waste material in later stages of the process.

The reactor system as shown in FIG. 1 comprises a first chamber 10, a first separating stage or separator 11, a further chamber 80 and a further separator 81. While the first chamber 10 and the first separator 11 are shown as separate elements in FIG. 1, they may be integrated, particularly in the form of a centrifuge chamber, as schematically represented by the dotted lines between items 10 and 11. The first chamber 10 and separator 11 are configured to mix waste polymer entering via inlet 14 with alcoholic solvent entering via inlet 13 such that at least part of the at least one dye is released from the waste polymer material in the alcoholic solvent without depolymerizing the 20 condensation polymer and at conditions preventing a reaction between the dye and the alcoholic solvent; and to separate the at least partially decolorized waste polymer from the alcoholic solvent. The at least partially decolorized waste polymer exits the first chamber 10 through outlet 19, while the dye-containing alcoholic solvent leaves the first separator 11 through exit 28.

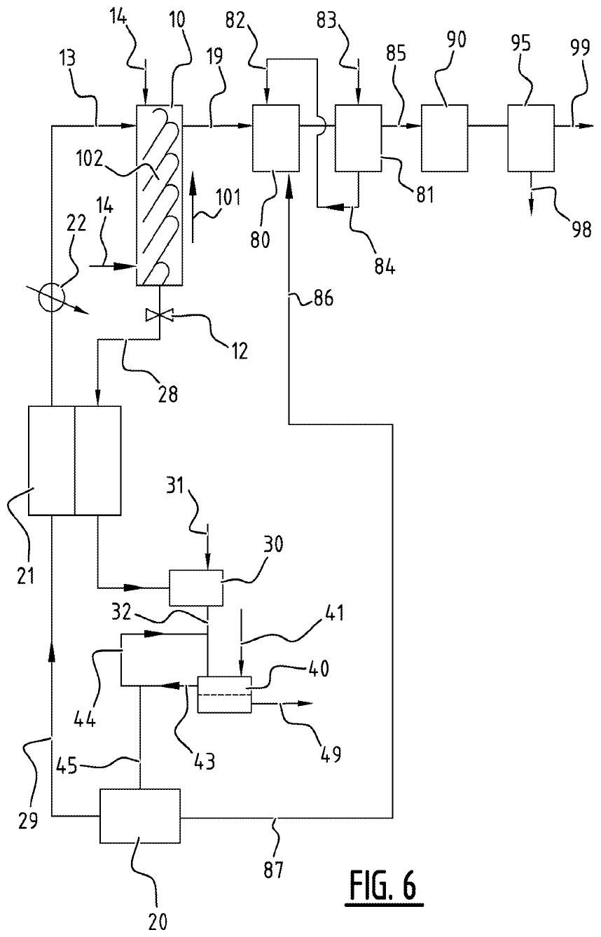

As shown in FIG. 6, the mixing chamber/separator combination may also be embodied as an extraction apparatus 100. The extraction apparatus 100 is solid-liquid separator wherein solid flakes of waste polymer are introduced via bottom inlet 14, whereas alcoholic solvent enters via inlet 13 at the top of the extraction apparatus 100. The waste polymer flakes are transported upwards according to arrow 101 by a conveying means such as a conveying screw 102. The waste polymer flakes are mixed with the alcoholic solvent flowing downwards and opposite to the conveying direction 101 so as to achieve extraction of the dyes from the waste polymer into the alcoholic solvent. The decolored waste polymer flakes leave the extrusion apparatus 100 at the top through outlet 19, while a bottom layer of the alcoholic solvent comprises the extracted dye, which dye-containing alcoholic solvent is removed via outlet 28.

The further chamber 80 configured to depolymerize the waste polymer and the further separator 81 may be separate or may be integrated. In one implementation—not shown—, the further chamber 80 may include a mixing vessel and one or more plug-flow depolymerization reactors. The latter is deemed beneficial, as the residence time in such plug flow reactor can be controlled easily. Moreover the plug-flow reactor may be embodied as a longitudinal cylindrical reactor, with a small cross-sectional area relative to the circumference. By thermally insulating such reactor, and/or adding heating elements such as wires at the outside, a constant temperature can be maintained, which is beneficial for the progress of the depolymerization in such further reactor chamber 80. However, good results for the depolymerization have also been achieved with a reactor in the form of a cylindrical vessel as known per se.

The reactor system as shown in FIG. 1 further comprises a separating stage 40 for separating the dye from the alcoholic solvent, and a storage vessel 20 for the alcoholic solvent. In one embodiment, the separating stage 40 may comprise an extraction apparatus. In another embodiment, the separating stage 40 may comprise a carbon absorption means for separating the dye from the alcoholic solvent, such as an activated carbon column. In yet another embodiment, the separating stage may comprise a distillation means for delivering a distillation stream comprising the alcoholic solvent in an output concentration of at least 95 wt-%. In a fourth embodiment, the separating stage 40 may comprise a nano-filtration stage for separating the dye from the alcoholic solvent. The separating stage 40 may also comprise a plurality of said embodiments, arranged in series. It is also possible to provide the separating stage 40 as a combination of any one of the disclosed embodiments.

In the shown embodiment, an additional mixing chamber 30 is present with an inlet 31 for a cooling agent that preferably is water or an aqueous solution. This mixing chamber 30 is however optional. Furthermore, a heat exchanger 21 is shown as well as a heater 22. This heater 22 may be embodied in any known form, for instance as a heat exchanger with steam, or as a heat exchanger with another liquid, such as oil. Additional components shown in the example of FIG. 1 are an adsorption column 90 and a crystallization unit 95. Furthermore, it is observed that more heat exchangers may be present than shown in FIG. 1, and that the alcoholic solvent may be distributed from the storage vessel 20 to more locations within the reactor system. Alternatively, use could be made of more than a single storage vessel, i.e. so as to ensure that the further chamber 80 is fed with an alcoholic solvent of higher purity than the first chamber 10.

In operation, the alcoholic solvent flows from the storage vessel 20 via solvent line 29 to the solvent inlet 13 of the first chamber 10. The solvent line 29 is provided with a heat exchanger 21 and heating means 22 to warm up the solvent to a desired temperature, for instance in the range of 100-160° C., preferably 110-140° C. Use is made of atmospheric pressure in this example, although use of other pressures is not excluded. The temperature of the solvent at the solvent inlet 13 of the first chamber 10 is controlled by means of a controller and suitably one or more sensors as is known per se in the art.

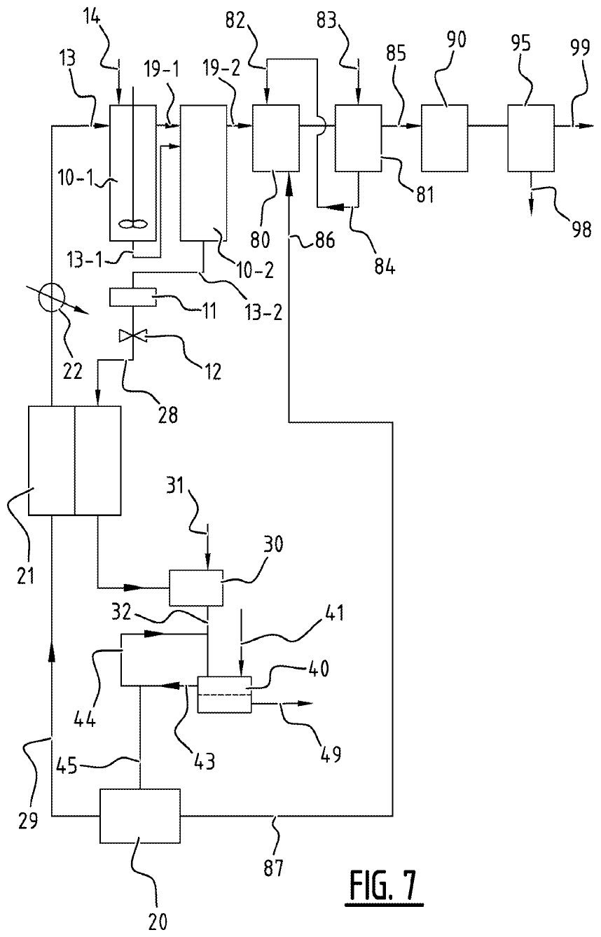

In the first chamber 10, the solvent is mixed with waste polymer material provided via inlet 14. In one example, the first chamber 10 is a batch reactor which is filled with waste polymer material prior to the provision of the solvent via the solvent inlet 13. It is not excluded that a plurality of chambers 10 would be present in parallel, so as to enable simultaneous and therewith semi-continuous processing. In another embodiment, a plurality of chambers 10 is provided in series, as shown in FIG. 7. Here, two first chambers (10-1, 10-2) are provided in series, in which decolored waste polymer stream 19-1 exiting the first chamber 10-1 is fed to the following first chamber 10-2 for further decoloring. The further decolored waste polymer leaves the following first chamber 10-2 as stream 19-2. Dye-containing alcoholic solvent 13-1 exiting the first chamber 10-1 is re-fed to the following first chamber 10-2 for taking up more dye from the decolored waste polymer stream 19-1. The increased dye-containing alcoholic solvent leaves the further first chamber 10-2 as stream 13-2. More than two first chambers may be provided in series, if desired.

As shown in FIG. 1 a mixer may be present in the first chamber 10. The mixer may be a mechanical stirrer. Alternatively, the first chamber 10 may be rotated in its entirety. Mixing is desired in order to obtain a uniform temperature distribution. In order to prevent that the temperature in the first chamber 10 exceeds a predefined operation temperature for the dye release step, it is preferred that the first chamber 10 does not contain any heating means, such as a heating means incorporated in the wall of the first chamber 10. Rather, heating of the waste polymer material occurs by means of heat transfer from the solvent. If desired or required, solvent may be refreshed during the processing of waste polymer material. Solvent may be removed via an outlet through the first separator 11. A valve 12 is shown in this FIG. 1 to indicate that the removal of a solvent stream out of the first chamber 10 may be controlled. If desired such removed solvent could be recirculated into the first chamber via a short-cut circulation line.

When a dye release step has been carried out in the first chamber at a predefined temperature during a predefined period and at a predefined concentration of waste polymer material relative to the alcoholic solvent, the first chamber 10 is emptied to the first separator 11. It is of course feasible that the emptying involves removal of the primarily liquid component. Rather than a centrifuge, the separator 11 could alternatively be embodied as a filter, for instance a crude filter having a mesh in the micrometer range. This is sufficient if the waste polymer material is provided in relatively big, discrete parts.

After removal from the first chamber 11, the solvent stream 28 comprising released dye typically has a temperature above 100° C. It typically requires cooling prior to exchange with an extraction solvent. Suitable halogenated alkanes have boiling points well below 100° C. Aromates such as xylene and toluene are also possible. In one implementation, they may also serve as a cooling agent. In order to cool the said solvent stream 28, the solvent stream 28 is subjected to heat exchange with the fresh solvent in the solvent line 29 in heat exchanger 21. The heat exchanger 21 can be embodied as known to a skilled person. Further heat exchangers may be present if so required. For instance, a further heat exchanger may be provided that exchanges heat with a liquid such as water. At various locations in the reactor system, water may be added as a cooling agent. In order to prevent too big expansion, water is suitably added as hot water, i.e. water of at least 70° C., or even water of at least 90° C. Another intermediate heating liquid, such as for instance oil, could also be used.

Downstream of the one or more heat exchanging steps, the solvent stream 28 may be cooled down further by addition of a cooling agent 31 in mixing chamber 30. As specified above, the cooling agent 31 may be water. Alternatively, the cooling agent 31 could be the extraction solvent. It is observed that this addition of cooling agent 31 in the mixing chamber 30 is optional, if so desired.

It can alternatively be that the cooling agent 31 is added in dependence of the temperature in the first chamber 10 and the flow rate of solvent in the solvent stream 28. It will be understood that the addition of a cooling agent is typically under control of a controller, and may be controlled in accordance with a predefined control protocol, for instance embodied in software.

The thus cooled down solvent stream 32 is fed into the separating stage 40, which is provided with a further inlet 41 for the extraction solvent. In one embodiment, the separating stage 40 is embodied as an extraction apparatus 40, which is a liquid-liquid separator wherein two immiscible liquids are mixed so as to achieve extraction of the dyes from the alcoholic solvent into the extraction solvent. It is not excluded that other types of extraction apparatus 40 would be applied, as known to the skilled person. The shown extraction apparatus 40 results in two layers of liquids. In the shown example, a bottom layer comprises the extraction solvent with extracted dye, which is removed via outlet 49. A top layer comprises the alcoholic solvent, which is removed via solvent outlet 43. In order to ensure good cleaning of the alcoholic solvent, the solvent may be recirculated to the extraction apparatus 40 via recirculation line 44. Alternatively, recirculation line 44 may lead to a separate extraction chamber (not shown). It will be further understood that either the solvent obtained at solvent outlet 43 or the dye comprising extraction solvent at outlet 49 may be subjected to further extraction and other treatment processes. Particularly, the dye comprising extraction solvent may be treated to obtain separate dyes in higher concentration. Use can be made of suitable purification and separation technology, including chromatography. It will be further understood that several extraction apparatus 40 may be used in parallel. A color sensor could be used to direct a solvent stream to a color-specific extraction apparatus, so as to minimize color contamination. Furthermore, the polymer waste material could be pretreated and separated into different, color-specific materials. Even though waste material of a single color typically comprises several dyes, the variety of colors is reduced.

In other embodiments, such as when the separating stage 40 comprises an activated carbon column, the purified or clean alcoholic solvent is removed via solvent outlet 43, while the dye remains in the activated carbon bed and may be removed via outlet 49.

In other embodiments, such as when the separating stage 40 comprises a nano-filtration stage, the purified or clean alcoholic solvent is removed via solvent outlet 43, while the dye may be removed via outlet 49.

The solvent stream that results from the solvent outlet 43 and is not recirculated by means of circulation line 44 is led as cleaned solvent stream 45 into the storage vessel 20. If desired for quality control, the cleaned solvent stream 45 may be sensed prior to entry into the storage vessel. When the solvent stream is not sufficiently clean, it can be led to a waste stream or a stream that is to be treated further. It has however been found in experiments leading to the invention, that the released dye is removed from the solvent stream 32 more adequately, when it has not been modified by reaction with the solvent in the course of the dye release step.

After the removal of the solvent from the first chamber 10, the polymer waste material may be led to the further chamber 80. This can occur in substantially dry form or after redispersion into fresh alcoholic solvent. It is not excluded that the polymer waste material is subjected to several dye release steps in the alcoholic solvent. These steps may be carried out at different temperatures, typically increasing from the first to the last step. Carrying out dye release in several steps at different temperatures has the benefit that dyes that more quickly release into the alcoholic solvent will be separated from dyes that release less quickly. The speed at which release occur may depend both on the chemical compounds of the dyes as well as on the arrangement of the dye within and/or at the surface of the waste material. Representative dye materials are known per se to the skilled person. If several release steps are carried out, they are in the example shown in FIG. 1 carried out in the same first chamber 10. Any desired variation in temperature may be achieved by means of the heating means 22. If any separate processing for the resulting solvent streams 28 would be desired, this can be implemented downstream.

The further chamber 80 is particularly configured for depolymerization of the polyester in the waste polymer material, which is preferably but not exclusively polyethylene terephthalate. The further chamber 80 is provided with an inlet 82 for depolymerization catalyst. A further inlet 86 is present for clean or purified recovered alcoholic solvent that originates from storage vessel 20. Inlet 86 is connected to storage vessel 20 through a line 87. Heating means will be present in the reactor 80 or work on the polymer waste stream 19 to achieve a desired depolymerization temperature. The further separator 81 is provided with an inlet 83 for an agent, more particularly water or an aqueous solution, to generate two different phases that can be separated in the separator 81. A first aqueous phase leaves the separator 81 via outlet 85 and is brought via an optional absorber 90 to a crystallization unit 95. This results in monomer product 99 as well as an aqueous stream 98 that may be removed as waste. The second phase is a slurry or solid phase and comprises oligomers, catalyst and additives. This is removed from the separator 81 via outlet 84 and is reused, optionally after processing as catalyst composition and inserted into the further chamber 80 via catalyst inlet. The said optional processing may involve a separation step to remove additives and pigments.

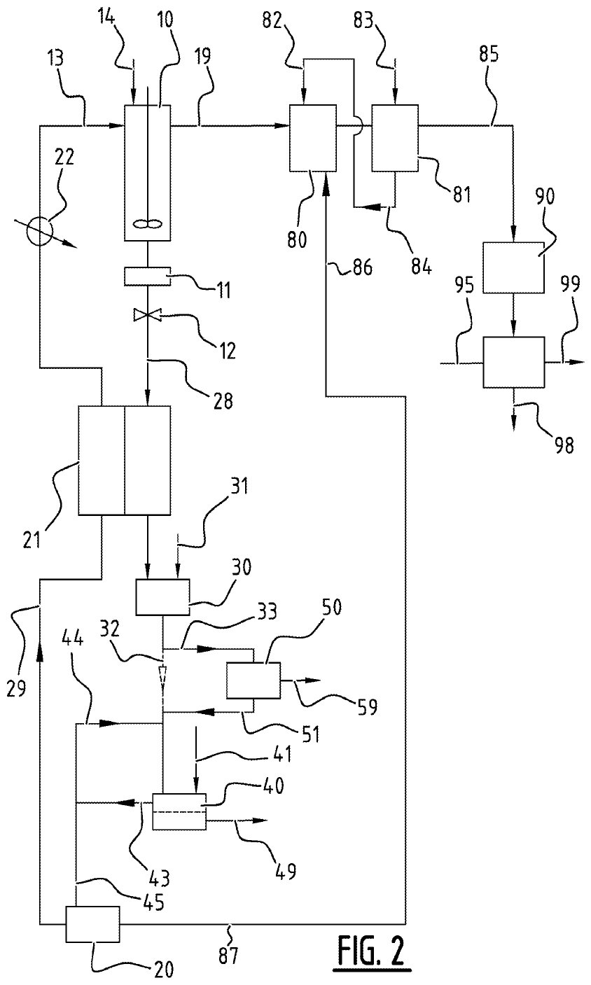

FIG. 2 shows a second example of a reactor system according to the invention. The reactor system in FIG. 2 differs from that in FIG. 1 in the presence of a filter unit 50 with a filter outlet 59. This filter unit 50 is configured so that polyamide is removed from the solvent stream 28. Thereto, the solvent stream 28 is diluted in the mixing chamber 30 with water from inlet 31. This results in precipitation of the polyamide, such as nylon 6 or nylon 6,6. The filter unit 50 separates the precipitated polyamide from the solvent stream 33. The remaining solvent stream 51, which may still contain any dye, is then led to the extraction apparatus 40. If the remaining solvent stream 51 would be completely devoid of colorants or dyes, it could be transported to the storage vessel 20 directly. It is observed for clarity that the polyamide removal requires heating to a temperature of at least 160° C. It is foreseen that the polyamide separation occurs after a dye release step. As discussed before, the first chamber is thereto refilled with alcoholic solvent that enters the first chamber 10 via the solvent inlet 13. A bypass 32 may exist around the filter unit 50, so that solvent streams 28 resulting from one or more dye release steps do not need to pass the filter unit 50. In the event that the waste polymer material would contain more than a single polyamide material, such as nylon 6,6 in addition to nylon 6, the temperature in the first chamber 10 during dissolution of the polyamide may be controlled so as to dissolve the nylon 6 selectively.

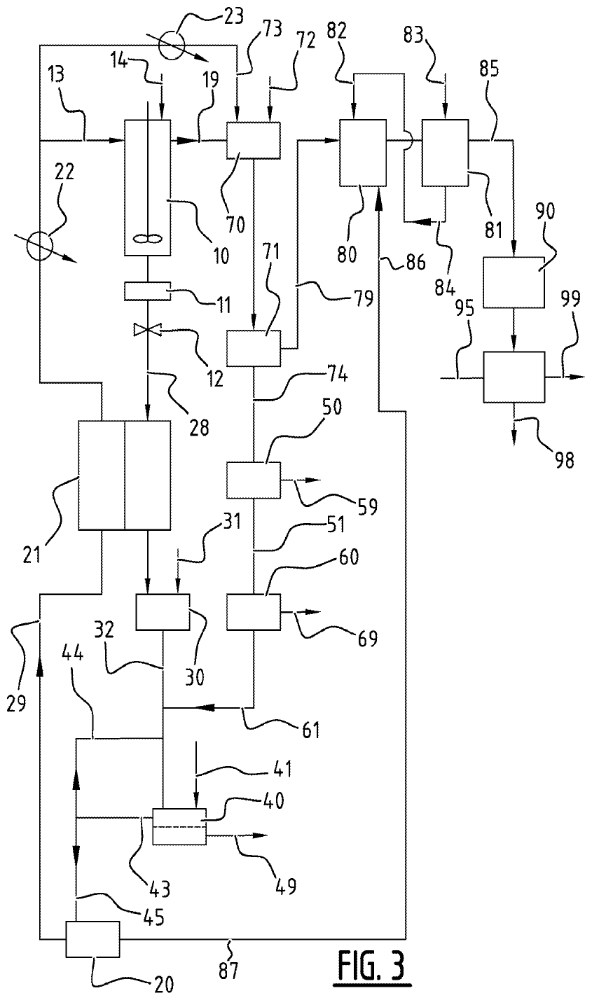

FIG. 3 shows a third example of a reactor system according to the invention. The reactor system in FIG. 3 differs from that in FIG. 2 in that a separate chamber 70 with concomitant downstream processing is provided for the separation of the polyamide out of the polymer waste material. This separate chamber 70 is provided with an inlet 73 for the alcoholic solvent, which is preheated to a desired temperature by means of additional heater 23. The further chamber additionally comprises an inlet 72 for water. Typically, the water will be added after a predefined period for dissolution of the polyamide. The water reduces the temperature in the chamber 70, so that the resulting mixture, typically a slurry of solid polyester in the alcoholic solvent in which the polyamide is dissolved, can be led over a separator 71, for instance a filter, such as a filter with a mesh of at least 0.2 microns. A stream 79 of solid polyester, typically with some alcoholic solvent that may be fresh alcoholic solvent, is subsequently led to the further chamber 80 for depolymerization. The solvent stream containing the polyamide 74 is led to the filter unit 50 for removal of the nylon 6,6. A further polyamide such as nylon 6 may be obtained separately from the nylon 6,6 in a separate filter unit 60 as stream 69 with the aqueous solvent stream 51 as input. The remaining solvent stream 61 is fed back to the separating stage 40.

It is observed that as a consequence of the addition of water during the process, for instance in chambers 30 and 70, the returning stream 45 to the storage vessel 20 will contain water in addition to the alcoholic solvent. Hence, the storage vessel 20 itself will also contain water. That is not deemed problematic. While the alcoholic solvent could be separated from water by means of distillation, a relatively low amount of water, for instance up to 20 wt % is not deemed problematic for the dye release steps. If the water concentration in the storage vessel would exceed a predefined concentration, fresh alcoholic solvent may be added, or the return stream 45 may be rejected as containing too much water.

### EXAMPLES

### Example 1: Dye Release by High Temperature Extraction from Polyester Textile

A 250 mL round bottom flask is filled with 125 g ethylene glycol (EG) and 1.7 g polyester textile to obtain a mass ratio of 1:75 PET:EG. The mixture is stirred and heated to the extraction temperature using an oil bath. The reaction proceeds for 1 to 2 h, taking samples over time. After this time, the hot reaction mixture is poured over a sieve to separate the solid textile fibers from the liquid stream of ethylene glycol. The solid textile fibers are rinsed with hot (120° C.) EG. Color changes were monitored visually and by UV-VIS spectrometry on the extracted colorants in EG.

The experiment was carried out for textile polyester colored with a yellow dye and for textile polyester colored with a blue dye. Observations are shown in Table 1 and 2 for the yellow and blue dye respectively.

TABLE 1
dye release for yellow colored textile polyester

| Temp | | UV-Vis results on colourants in EG | |
|---|---|---|---|
| (° C.) | Duration | UV-Vis absorbance | Observations over time |
| 197 | 1 h | 1^{st} Abs peak @ 445 nm | Increase of absorbance over time during |
| | | during heating (125° C.) | entire experiment. |
| | | 2^{nd} Abs peak @ 427 nm (20 | Partial depolymerization of textile observed |
| | | min at 197° C.), shift to 423 | |
| | | nm (40 min at 197° C.) | |
| 150 | 1 h | 1^{st} Abs peak @ 445 nm | Increase of absorbance stagnates shortly |
| | | during heating (125° C.) | after 150° C. was reached. |
| 150 | 2 h | 1^{st} Abs peak @ 445 nm | Increase of absorbance stagnates shortly |
| | | during heating (125° C.) | after 150° C. was reached. |
| | | 2^{nd} Abs peak @ 427 nm (120 | Partial depolymerization of textile observed |
| | | min at 150° C.) | after 60 min |
| 120 | 2 h | 1^{st} Abs peak @ 445 nm at | Increase of absorbance stagnates after 40 |
| | | 120° C. | minutes |

TABLE 2
dye release for blue-colored polyester textile

| Temp | | UV-Vis results on colorants in EG | |
|---|---|---|---|
| (° C.) | Duration | UV-Vis absorbance | Observations over time |
| 197 | 1 h | 1^{st} Abs peak @ 590 nm during heating | Increase of absorbance |
| | | (125° C.), shifts to 570 nm (190° C.), then | stagnates at 170° C. |
| | | disappears (10 min at 197° C.) | Partial depolymerization of |
| | | 2^{nd} Abs peak @ 370 nm during heating | textile observed |
| | | (190° C.) | |
| | | 3^{rd} Abs peak @ 432 nm (197° C.) | |
| 150 | 2 h | 1^{st} Abs peak @ 590 nm during heating | Increase of absorbance |
| | | (100° C.), shifts to 577 nm (150° C.) | stagnates shortly after 150° C. |
| | | 2^{nd} Abs peak @ 605 nm (150° C.), decrease of | was reached. |
| | | absorbance (80 min at 150° C.) | Partial depolymerization of |
| | | | textile observed after 80 min |
| 120 | 2 h | 1^{st} Abs peak @ 577 nm (120° C.) | Increase of absorbance |
| | | 2^{nd} Abs peak @ 605 nm (120° C.) | stagnates after 60 min |

### Example 2: Dye Separation by Solvent-Solvent Extraction

The EG liquid stream is purified by a liquid-liquid extraction in which dyes transfer from the EG phase to the extraction solvent phase. The colored EG stream is mixed with extraction solvent in a 50:50 mass ratio. The extraction solvent was not miscible with EG. A two-phase system is obtained. In the tested systems, the bottom phase is the extraction solvent containing dye. Residual dye in the EG phase is removed by multiple extraction cycles. Extraction is performed at room temperature.

It is found that both for the solution obtained from dye release from yellow polyester and blue polyester extraction to p-xylene, dichloromethane and chloroform is feasible, however, only for the dyes that are not modified during the extraction. Acetic acid and dimethylformamide as second extraction solvents turn out to be miscible with ethylene glycol and are not suitable for the extraction. For the blue dye, the extraction in dichloromethane is preferred over the extraction in chloroform.

### Example 3: Dye Release by High Temperature Extraction from PET Bottle Flakes

Orange-colored feedstock in the form of flakes from PET bottles was used in a process equal to Example 1. In the PET bottles, the PET is at least partially crystalline. High temperature extraction was tested at different temperatures.

TABLE 3
dye release for orange colored flakes from PET bottles

| Temp | | UV-Vis results on colorants in EG | |
|---|---|---|---|
| (° C.) | Duration | UV-Vis absorbance | Observations over time |
| 197 | 1 h | 1^{st} Abs peak @ 420 nm during heating | Increase of absorbance |
| | | (150° C.) | almost stagnates after 40 |
| | | 2^{nd} Abs peak @ 440 nm during heating | min |
| | | (150° C.) | |
| 150 | 2 h | 1^{st} Abs peak @ 420 nm (150° C.) | Increase of absorbance |
| | | 2^{nd} Abs peak @ 440 nm (150° C.) | over time |
| 120 | 2 h | 1^{st} Abs peak @ 420 nm (20 min at 120° C.) | Overall very low |
| | | 2^{nd} Abs peak @ 440 nm (20 min at 120° C.) | absorbance |

It can be seen that for PET flakes the temperature of 120° C. is too low to achieve more than marginal release of the dye. Most of the dye remains kept in the PET flakes and will be released during depolymerization. Higher temperatures are feasible so as to release the dye prior to degradation and to prevent contamination of the product containing the monomer with the dye, in case that the dye would dissolve into the aqueous phase. Upon extraction of the dye with dichloromethane and chloroform as in Example 2, it turns out to be more difficult to remove the dye from the ethylene glycol than for the dyes released in Examples 1 and 2 and originating from textile waste polymers.

### Example 4: Dye Separation by Activated Carbon (AC)

Adsorption extraction by activated carbon was performed after first extracting by high temperature mixing at 150° C., as described in Example 1. Every adsorption analysis was performed in duplicate for reproducibility determinations. Colored extraction solvent, resulting from the optimal textile extraction method was added to a round bottom flask. Optionally, the solution was heated to a temperature representative for the industrial application of this method (80° C.) before mixing with amounts of activated carbon to obtain 400 to 800 mg/L concentrations. The solution was mixed for 2 hours at 120 rpm and samples were taken after 5, 10, 15, 20, 40, 60, 80, 100 and 120 minutes of mixing for determination of the color removal yield over time. Each sample was processed immediately to separate the activated carbon and prevent additional reactions. By use of 3 minutes centrifugation at 6000 rpm, the ethylene glycol and activated carbon were separated in which the supernatant was the (partially) decolored ethylene glycol. The samples were analyzed with UV-Vis spectroscopy to determine the color removal yield over time and the total color removal yield, showing that multiple cycles performed under optimal conditions (500 mg/L carbon dosage, 80° C.) result in color removal yields from 70% to 97%.

### Example 5: Recovery of Extraction Solvent

An amount of 250 g of EG is mixed with 16.7 g of polyester textile and heated to 150° C. using an oil bath. The EG is cooled down to room temperature and the EG and polyester textile are separated by sieving. The separated EG is then distilled and the fraction that comes off at a temperature of 197° C. is collected as recovered EG. An UV-Vis analysis is performed and the results are shown in Table 4.

TABLE 4
example of recovery of extraction solvent

| | Relative absorbance |
|---|---|
| Sample: | [—] at 557 nm: |
| Start of the extraction | 0.1 |
| When extraction reaches T = 150° C. | 7 |
| When extraction has cooled down to RT | 5 |
| Recovered extraction solvent | 0.1 |
| Residue after recovery of extraction solvent | 240 |

### Example 6: Depolymerization with Recovered Alcoholic Solvent from Active Carbon Purification

A 1000 mL beaker is filled with 250 g ethylene glycol and the EG is stirred and heated to 150° C. using an oil bath. An amount of 16.7 g polyester textile is then added to the beaker to obtain a mass ratio of about 1:15 PET:EG. The extraction is complete when 150° C. is reached. After this time, the hot (150° C.) reaction mixture is poured over a (tea) sieve to separate the solid textile fibers from the liquid stream of colored ethylene glycol. The beaker containing the colored EG is then filtered over the carbon filter cake (at 90° C.) and the filtrate is collected in the Buchner flask, and then transferred in a 250 mL flask.

After the pre-treated feedstock and the colored EG are separated and the colored EG is purified by means of active carbon, as disclosed above, the purified EG is used in a depolymerization reaction of the polyester.

The reference scale of a laboratory depolymerization experiment is 125 g ethylene glycol and 16.7 g PET in a 250 ml flask. Magnetic catalyst is added in the ratio of 0.01:10:75 catalyst:PET:EG (based on weight).

After removal of the magnetic catalyst, the mixture is centrifuged at a temperature of about 100° C. and filtered. The filtrate is then placed in a crystallization dish while cooling to a temperature of 20° C. The solid BHET crystals are then filtered over a 12-15 micron paper filter and again transferred to a crystallization dish for further drying at in a vacuum oven at 60° C. and 200 mbar. The quality of the product is measured by HPLC, XRF and colorimetry.

### Example 7: Depolymerization with Recovered Alcoholic Solvent from Distillation

The above experiment is repeated but the separated colored EG is purified by means of distillation (97% of the EG is recovered, 3% stays as residue). The purified EG is again used in a depolymerization reaction of the polyester, as described above for Example 6.

The results are given in Table 5. The BHET produced by depolymerization using the recovered purified ethylene glycol as reactive solvent is on specification with respect to b* value and iron-ion content. The purity of the samples is above 93 wt % and the indicative specs for a* and L* are satisfactory.

TABLE 5
properties of obtained BHET after depolymerization

| Experiment | wt. % BHET | [Fe] | b* | A* | L* |
|---|---|---|---|---|---|
| Example 6 | 98.04 | 0.4 | 0.36 | 0.61 | 93.33 |
| Example 7 | 93.73 | 0.5 | 1.49 | −0.21 | 92.93 |

The UV-VIS results show that substantially all the dye has been separated from the ethylene glycol; which is given in Table 6.

TABLE 6
UV-VIS dye absorbance in recovered EG and residue

| Sample: | Relative absorbance [—] at 588 nm: |
|---|---|
| Recovered EG | 0.121 |
| Residue | 6.66 |

### Example 8: Efficiency of Multiple Pre-Treatment Cycles

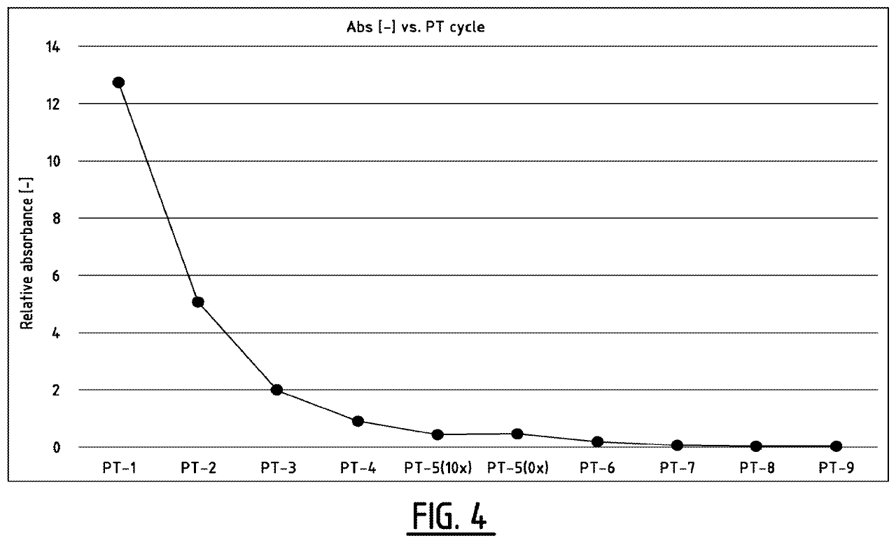

A 500 mL beaker is filled with 250 g ethylene glycol and the EG is stirred and heated to 150° C. An amount of 16.7 g polyester textile is then added to the beaker to obtain a mass ratio of about 1:15 PET:EG. The extraction is complete when the mixture was stirred at 150° C. for 10 minutes. After this time, the hot (150° C.) reaction mixture is poured over a (tea) sieve to separate the solid textile fibers from the liquid stream of colored ethylene glycol. The beaker containing the colored EG is then measured with UV-VIS and the results are shown in FIG. 4, which shows the relative absorbance of the colored EG after every pre-treatment cycle. The partially decolored textile is used again in a subsequent cycle, where the ratio during the pre-treatment mixture always meets 1:15 PET:EG.

### Example 9: Effect of Multiple Pre-Treatment Cycles on Depolymerization Time

A post-consumer polyester textile feedstock with various colors and dyes was subjected to multiple pre-treatment cycles, as described above for Example 8. Two samples were made with the same polyester textile composition but pre-treated with one or six cycles. After the pre-treatment cycles, the polyester samples were depolymerized with a reaction mixture concentration of 0.01:10:75 catalyst:PET:EG, as described for Example 6.

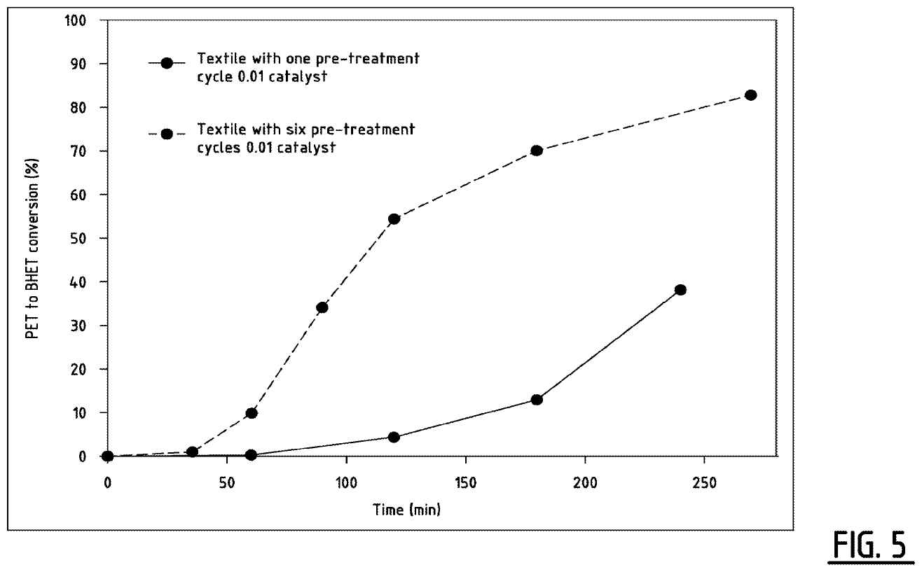

The results of the depolymerization are shown in FIG. 5, which specifically shows the PET to BHET conversion of the two polyester textile depolymerizations. The two polyester textile depolymerizations show different times to obtain high or lower conversion. It is clear that the polyester textile with only one pre-treatment cycle reacts the slowest. While the conclusion of the experiments is that more pre-treatment cycles make the depolymerization faster with higher conversion.

### Example 10: Effect of PET:EG Ratio

A post-consumer polyester textile feedstock with a dark blue color and dye was subjected to a dye release by high temperature extraction as described above for Example 1. For sample 1, a EG:PET ratio of 7.5:1 was used, which is outside the claimed range, whereas for samples 2 and 3, the EG:PET ratio was 75:1, which is within the claimed range. The dark blue dye was then separated by solvent-solvent extraction according to the procedure of Example 2. After this, the polyester samples were depolymerized with a reaction mixture concentration of 0.01:10:75 catalyst:PET:EG, and using the recovered EG solvent from the solvent-solvent extraction.

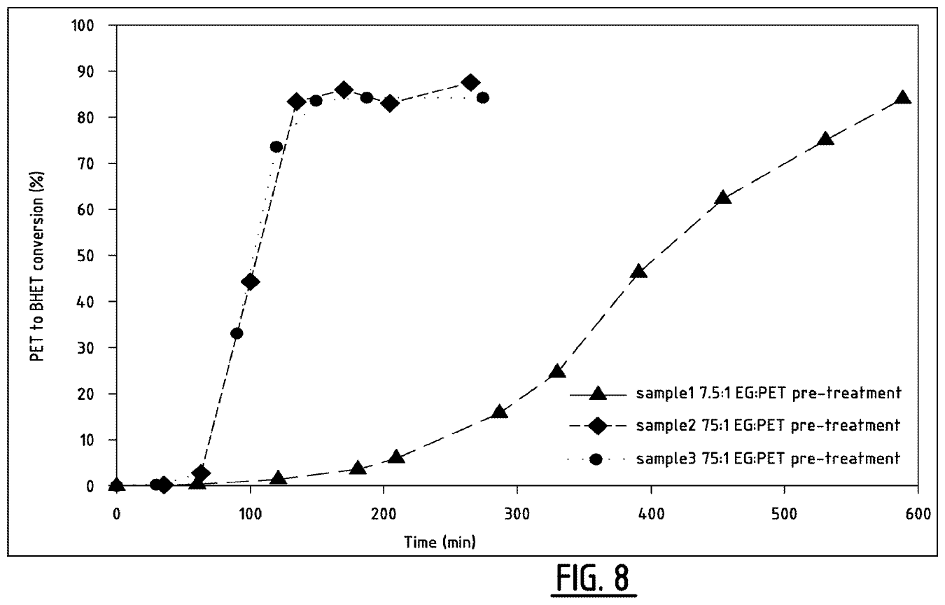

The results of the depolymerization are shown in FIG. 8, which shows the PET to BHET conversion with time of samples 1-3. The depolymerization for sample 1 shows a much longer reaction time for a given conversion. The depolymerizations for samples 2 and 3 on the other hand show conversion rates that are much faster, and in fact quite similar to a depolymerization that uses fresh EG.

Color results are given in Table 7. The mother liquor (ML) and the BHET produced by depolymerization using the recovered purified ethylene glycol as reactive solvent show very different color values (exemplified by b* which is a measure of yellowing) between samples 1 (Comparative) and 2 (according to the claimed invention. The mother liquor (ML) quality difference in particular is significant between samples 1 and 2. This shows that a pre-treatment with a relatively high EG:PET ratio, as claimed, increases the overall quality considerably. The overall quality improvement is especially seen and proved using the b* value.

TABLE 7
properties of obtained mother liquor
(ML) and BHET after depolymerization

| Sample | b* |
|---|---|
| Sample 1 ML | 21.25 |
| Sample 2 ML | 3.36 |
| Sample 1 BHET | 1.34 |
| Sample 2 BHET | −0.76 |

It turned out that the mother liquor (ML) of sample 1 (Comparative) is much more colored (dark yellow) than the mother liquor (ML) of sample 2 (according to the claimed invention). The latter is substantially colorless.

### Example 11: Removal of Other Impurities Such as Flame Retardants

A post-consumer polyester textile feedstock with a phosphorous flame retardant was provided, and subjected to a phosphoric acid release by high temperature extraction as described above for Example 1. For sample 1, no pre-treatment was carried out (Comparative), whereas for sample 2, a EG:PET ratio of 15:1 was used during phosphoric acid release, while for sample 3, a two-step phosphoric acid release was used with a EG:PET ratio of 15:1 in each step. The phosphoric acid was then separated by solvent-solvent extraction according to the procedure of Example 2. After this, the polyester samples were depolymerized with a reaction mixture concentration of 0.01:10:75 catalyst:PET:EG, and using the recovered EG solvent from the solvent-solvent extraction.

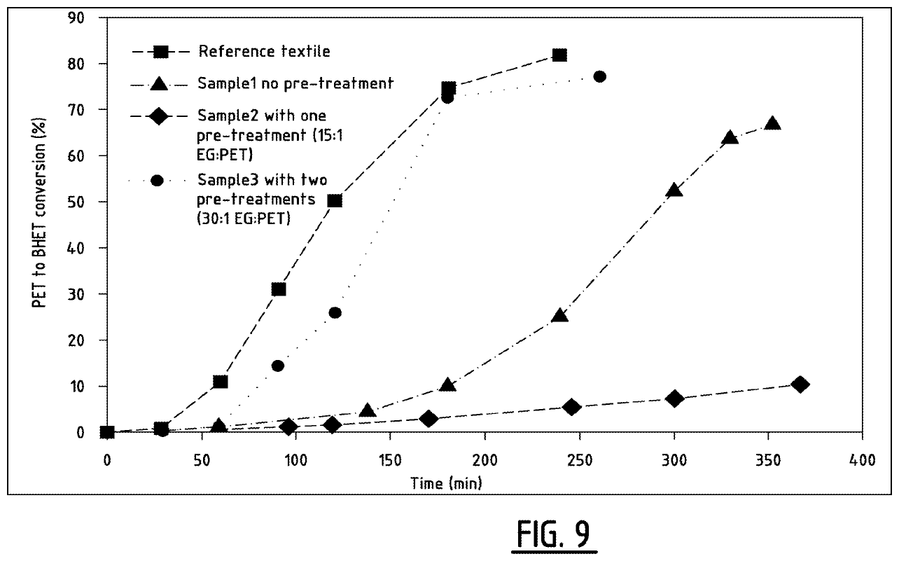

The results of the depolymerization are shown in FIG. 9, which shows the PET to BHET conversion with time of samples 1-3. Also, a reference sample using a textile feedstock without any flame retardant is also included. The depolymerizations for sample 1 shows a much larger reaction time for a given conversion than those for samples 2 and 3. The depolymerizations for sample 3 shows a conversion rate that is quite similar to the reference sample which does not use any flame retardant in its feedstock.

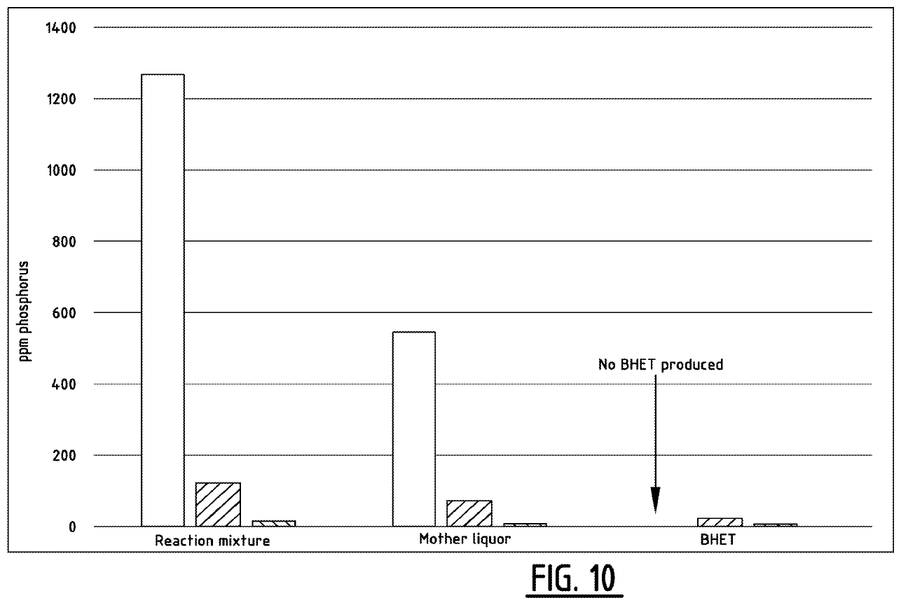

FIG. 10 finally shows the amount of phosphoric acid that remained in the reaction mixture after depolymerization for samples 1 to 3 (from left to right in each bundle of bars). The middle bundle of bars shows the amount of phosphoric acid that remained in the mother liquor after crystallization, whereas the bundle of bars to the right shows the amount of phosphoric acid that remained in the BHET produced. Please note that for sample 1 (no pre-treatment), BHET was not produced, as indicated. The results clearly show the beneficial effect of the release step, as claimed.

1. Method of depolymerizing a waste polymer material into monomers, which waste polymer material comprises a condensation polymer and at least one dye, the method comprising the steps of:
releasing at least part of the at least one dye from the waste polymer material in an alcoholic solvent without depolymerizing the condensation polymer and at conditions preventing a reaction between the dye and the alcoholic solvent, wherein the alcoholic solvent is a polyol, and is added in a weight ratio of the alcoholic solvent to the waste polymer material of between 200:1 and 10:1;
separating the at least partially decolorized waste polymer from the alcoholic solvent;
separating the at least one dye from the alcoholic solvent in an alcoholic solvent separation step, so as to recover the alcoholic solvent;
depolymerizing the condensation polymer in alcoholic solvent by using a catalyst, wherein the alcoholic solvent is substantially the recovered alcoholic solvent obtained in the alcoholic solvent separation step.

2. Method according to claim 1, wherein the alcoholic solvent is added in a weight ratio of the alcoholic solvent to the waste polymer material of between 150:1 and 20:1, more preferably of between 150:1 and 30:1, even more preferably of between 120:1 and 40:1.

3. Method according to claim 1, wherein the alcoholic solvent separation step is carried out such that the recovered alcoholic solvent has a purity of at least 95 wt-%, preferably of at least 98 wt-%, and more preferably of at least 99 wt-%.

4. Method according to claim 1, wherein the step of releasing at least part of the at least one dye from the waste polymer is carried out without a non-alcoholic solvent.

5. Method according to claim 1, wherein the alcoholic solvent separation step comprises extracting the dye from the alcoholic solvent with a second solvent that is immiscible with the alcoholic solvent.

6. Method according to claim 1, wherein the alcoholic solvent separation step comprises extracting dye from the alcoholic solvent with a carbon absorption means.

7. Method according to claim 1, wherein the alcoholic solvent separation step comprises treating the alcoholic solvent in a distillation stage to deliver a distillation stream comprising the alcoholic solvent in an output concentration of at least 95 wt-%,

8. Method according to claim 1, wherein the alcoholic solvent separation step comprises a nano-filtration step to separate the dye from the alcoholic solvent.

9. Method according to claim 1, wherein the alcoholic solvent has a boiling temperature at atmospheric pressure of at least 160° C., preferably of at least 180° C., more preferably of at least 190° C.

10. Method according to claim 1, wherein releasing at least part of the at least one dye from the waste polymer material in the releasing step is carried out at a temperature of at most 160° C.

11. Method according to claim 5, wherein the second solvent has a lower polarity than the alcoholic solvent.

12. Method according to claim 1, wherein the waste polymer material originates from textile for at least 30 vol %, preferably for at least 50 vol %, more preferably for at least 70 vol %, or even more preferably for at least 90 vol %.

13. Method according to claim 1, wherein 50-100 wt % of the at least one dye is removed from the waste polymer material, more preferably 80-98 wt %.

14. Method according to claim 1, wherein the releasing step is carried out in a rotating vessel, preferably a centrifuge.

15. Method according to claim 14, wherein the alcoholic solvent is heated prior to entry into the rotating vessel to a predefined temperature configured for releasing the at least part of the at least one dye from the waste polymer material.

16. Method according to claim 15, wherein during releasing the alcoholic solvent is refreshed and treated to have the predefined temperature.

17. Method according to claim 14, wherein the releasing step comprises a first and a second releasing step, wherein the second releasing step uses recovered alcoholic solvent from the first releasing step, and/or wherein the second releasing step is carried out at a higher temperature than the first releasing step.

18. Method according to claim 17, wherein the first and second releasing step are configured for selective release of first and second colorants.

19. Method according to claim 1, wherein the waste polymer comprises a polyester.

20. Method according to claim 19, wherein the waste polymer further comprises a polyamide.

21. Method according to claim 20, wherein the polyester and the polyamide are separated from each other subsequent to separating the waste polymer from the alcoholic solvent and before catalytic depolymerization of the polyester.

22. Method according to claim 1, wherein the catalyst for depolymerizing the condensation polymer comprises a functionalized magnetic particle that is functionalized with a catalytic moiety.

23. Method according to claim 1, wherein the alcoholic solvent is a glycol, more preferably an alkylene glycol, selected from ethylene glycol (1,2-ethane diol), propylene glycol (1,3-propane diol), 1,4-butane diol and 1,5-pentane diol.

24. Method according to claim 5, wherein the second solvent is chosen from the group of alkanes, cycloalkanes, esters, and ethers, with the exclusion of aromatics.

25. Method according to claim 1, wherein the reaction to be prevented is an esterification or trans-esterification reaction of the dye with the alcoholic solvent, particularly ethylene glycol.

26. System for depolymerizing a waste polymer material comprising a condensation polymer and a dye, the system comprising:
heating means for an alcoholic solvent;
a first chamber for mixing the waste polymer material in the alcoholic solvent, wherein the waste polymer material is heated up by means of the alcoholic solvent, said first chamber being provided with an inlet for the alcoholic solvent and with an inlet for the waste polymer material, wherein in use upon heating up of the waste polymer material the dye will be released from the waste polymer material at least partially and into the alcoholic solvent;
a first separator, optionally integrated with the first chamber, for separating the waste polymer material in solid form from the alcoholic solvent and having a first outlet for the alcoholic solvent;
a further separating stage for separating the dye from the alcoholic solvent to obtain recovered alcoholic solvent, said separating stage being arranged downstream of the first outlet of the first separator;
a storage vessel for the recovered alcoholic solvent, which storage vessel includes an inlet coupled to the separating stage, and further an outlet coupled to a further chamber;
which further chamber is provided for depolymerization of the condensation polymer, and is provided with a first inlet for the waste polymer material, optionally with a further inlet for depolymerization catalyst, and with a further inlet for the recovered alcoholic solvent.

27. System according to claim 26, wherein the first chamber and the first separator are integrated and jointly constitute a mixing/separator unit in which the waste polymer material may be retained (statically) or conveyed in the first chamber and the alcoholic solvent and/or the recovered alcoholic solvent is fed to the first chamber and led through or along the waste polymer material to extract the dye contained therein and exit the dye-containing alcoholic solvent through the first outlet.

28. System according to claim 26, wherein the first chamber and the first separator jointly constitute a centrifuge chamber, wherein at least one valve is present such that the alcoholic solvent may be selectively retained in the centrifuge chamber or removed therefrom.

29. System according to claim 26, wherein the releasing stage comprises an extraction apparatus for extracting the dye from the alcoholic solvent with a second solvent that is immiscible with the alcoholic solvent, said extraction apparatus being provided with an inlet for the second solvent.

30. System according to claim 26, wherein the separating stage comprises a carbon absorption means for separating the dye from the alcoholic solvent.

31. System according to claim 26, wherein the separating stage comprises a distillation means for delivering a distillation stream comprising the alcoholic solvent in an output concentration of at least 95 wt-%.

32. System according to claim 26, wherein the separating stage comprises a nano-filtration stage for separating the dye from the alcoholic solvent.

33. System according to claim 26, wherein a filter is arranged downstream of said first outlet of the first separator for carrying out a solid-liquid separation treatment at different conditions than in the first separator.

34. System according to claim 33, wherein cooling means are present upstream of the filter and downstream of the first outlet.

35. System according to claim 26, wherein the system further comprises a further separator for separating a catalyst from a solution comprising monomers after depolymerization of the condensation polymer.

36. System according to claim 26, wherein the further chamber comprises a further inlet for water.

37. System according to claim 26, wherein the heating means are arranged downstream of the storage vessel and wherein a heat exchanger is present upstream of said heating means for heat exchange between the alcoholic solvent from the storage vessel and a stream of alcoholic solvent comprising released dye originating from the first separator.
